(19) United States
(12) Patent Application Publication
(10) Pub. No.: US 2009/0003945 A1
(43) Pub. Date: Jan. 1, 2009

(54) MACHINE TOOL

(75) Inventors: JUN-QI LI, Shenzhen (CN); QING LIU, Shenzhen (CN); TAKEO NAKAGAWA, Tokyo (JP)

Correspondence Address: PCE INDUSTRY, INC.;ATT. CHENG-JU CHIANG, 458 E. LAMBERT ROAD, FULLERTON, CA, 92835, US

(73) Assignees: HONG FU JIN PRECISION INDUSTRY (ShenZhen)CO., LTD., Shenzhen City (CN); HON HAI PRECISION INDUSTRY CO., LTD., Tu-Cheng (TW)

(21) Appl. No.: 11/944,467

(22) Filed: Nov. 23, 2007

(30) Foreign Application Priority Data
Jun. 28, 2007 (CN) 200710200912.3

(51) Int. Cl. B23B 39/16

(52) U.S. Cl. 408/42

(57) ABSTRACT

An exemplary machine tool (20) includes a main equipment (30) and a plurality of peripheral equipments. The main equipment has a base (31) and a drill (34) disposed on the base. The peripheral equipments are separate from and connected to the main equipment. A precision of the machine tool does not worsened.

### CROSS-REFERENCE TO RELATED APPLICATIONS

This application is related to three co-pending U.S. patent applications (Attorney Docket No. US14203, US14204, & US14205), entitled “MACHINE TOOL”, by Takeo Nakawaga et al. Such applications have the same assignee as the instant application and are filed concurrently herewith. The disclosure of the above-identified applications is incorporated herein by reference.

### BACKGROUND OF THE INVENTION

1. Field of the Invention

The present invention relates to machine tools, and particularly to, a machine tool with a precision not be worsened by peripheral equipments.

2. Discussion of the Related Art

In the manufacturing field, a main equipment of a machine tool and peripheral equipments of the machine tool are often combined as one integrated unit. By integrating the main equipment and the peripheral equipments, the integrated unit would occupy less space and avoid combining and disassembling the peripheral equipments from/to the main equipment when relocating the machine tool.

However, combining some of the peripheral equipments, such as combining a power cabinet with the main equipment has disadvantages. For example, there are many electronic components such as relays mounted inside the power cabinet. Thus, when the machine tool is operating, the electronic components inside the power cabinet generate heat. The heat travels to the main equipment, and affecting/increasing a final temperature of the main equipment. The final temperature can be excessively high and may deform a main spindle and/or a cutting tool of the main equipment. Thus, a precision of the machine tool is decreased.

Therefore, a machine tool which can overcome the above-described problem is desired.

### SUMMARY

An exemplary machine tool includes a main equipment and a plurality of peripheral equipments. The main equipment has a base and a drill disposed on the base. The peripheral equipments are separate from and connected to the main equipment.

Other advantages and novel features will become more apparent from the following detailed description when taken in conjunction with the accompanying drawings.

### BRIEF DESCRIPTION OF THE DRAWINGS

The components in the drawings are not necessarily drawn to scale, the emphasis instead being placed upon clearly illustrating the principles of the present machine tool. Moreover, in the drawings, like reference numerals designate corresponding parts throughout the several views, and all the views are schematic.

FIG. 1 is an isometric view of a machine tool according to an embodiment of the present invention.

FIG. 2 is an isometric view of a main equipment of the machine tool of FIG. 1.

FIG. 3 is an isometric view of the main equipment of FIG. 2 without a cover.

FIG. 4 is an isometric view of a bit holder of the main equipment of FIG. 3.

### DETAILED DESCRIPTION OF THE EMBODIMENTS

The present invention provides a machine tool. An exemplary machine tool is described in detail as follows.

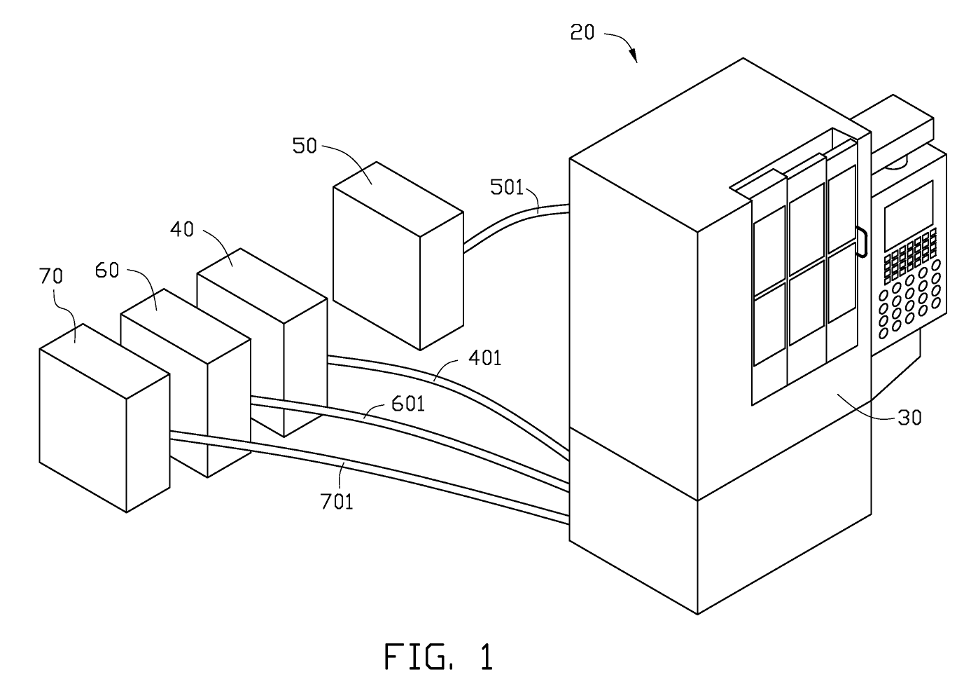

Referring to FIG. 1, a milling machine is taken as an example as a machine tool 20, and includes a main equipment 30, a power cabinet 40, a dust remover equipment 50, a compressor 60, and a cooling equipment 70. Alternatively, the machine tool 20 can be other types of machines such as lathes and grinding machines.

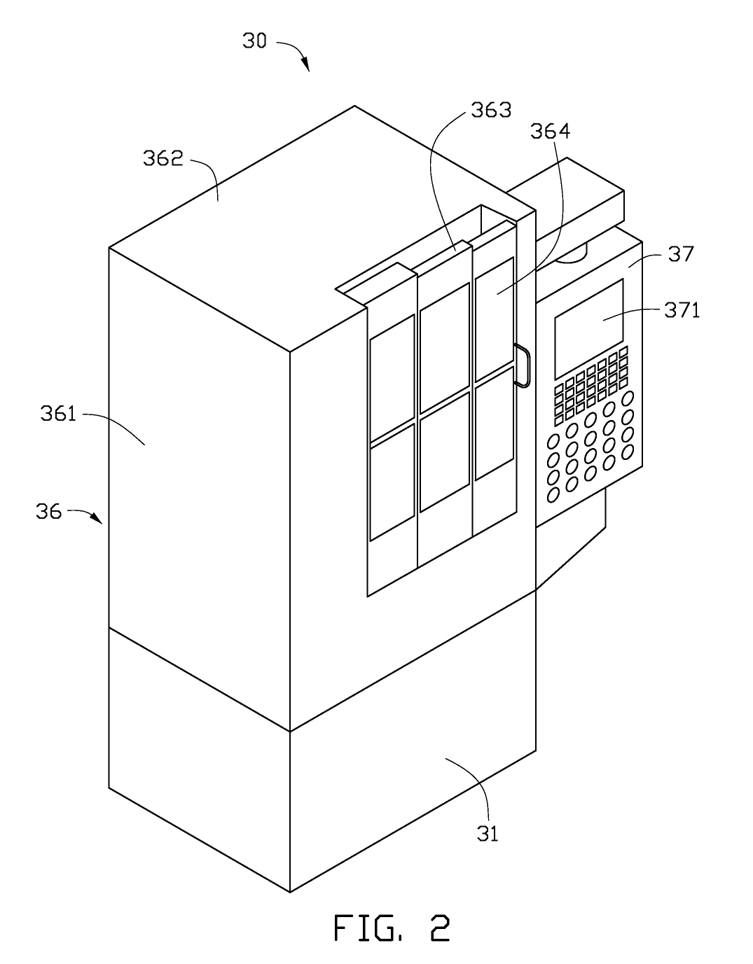

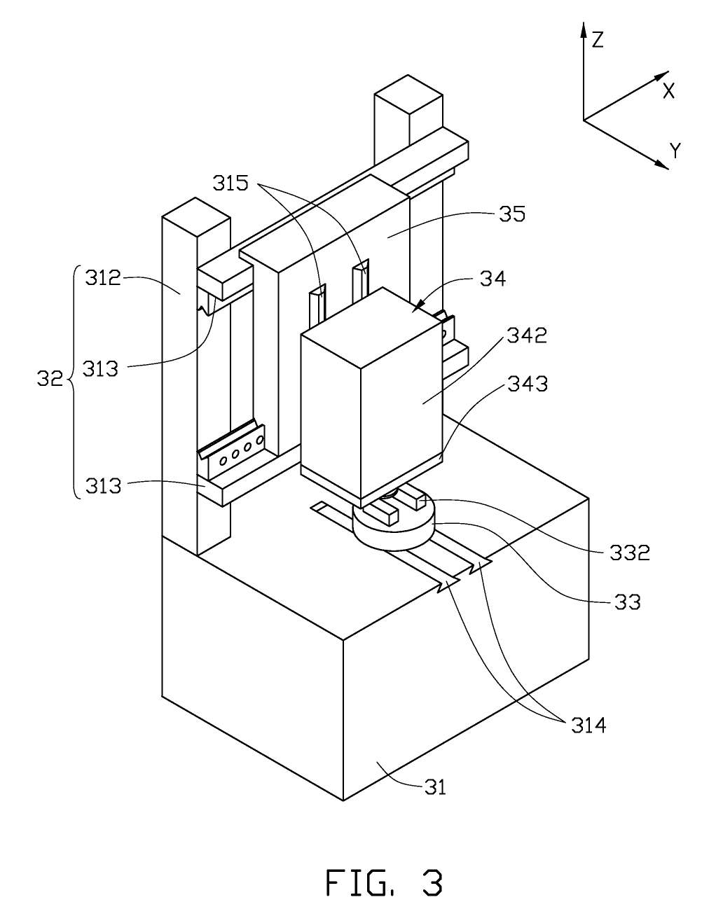

Referring to FIGS. 2 and 3, the main equipment 30 includes a base 31, a tool rack 32, a slidable platform 33, a drill 34, a drill holder 35, a cover 36, and a controller 37.

The base 31 includes a top surface. A pair of guiding grooves 314 are defined in the top surface of the base 31. As seen in FIG. 3, the pair of guiding grooves 314 run parallel to the Y-axis and are configured for receiving the slidable platform 33 and guiding the slidable platform 33 to move parallel to the Y-axis.

The tool rack 32 includes a pair of support arms 312 extending perpendicular from the top surface of the base 31. As seen in FIG. 3, the pair of support arms 312 extend parallel to the Z axis. A pair of horizontal guide rails 313 are fixed between the pair of support arms 312. The horizontal guide rails 313 run parallel to the X-axis and are configured for receiving the drill holder 35 and guiding the drill holder 35 to slide parallel to the X-axis.

A pair of vertical guiding chutes 315 are defined in the drill holder 35. The pair of vertical guiding chutes 315 run parallel to the Z-axis and are configured for receiving the drill 34 and guiding the drill 34 to slide parallel to the Z-axis.

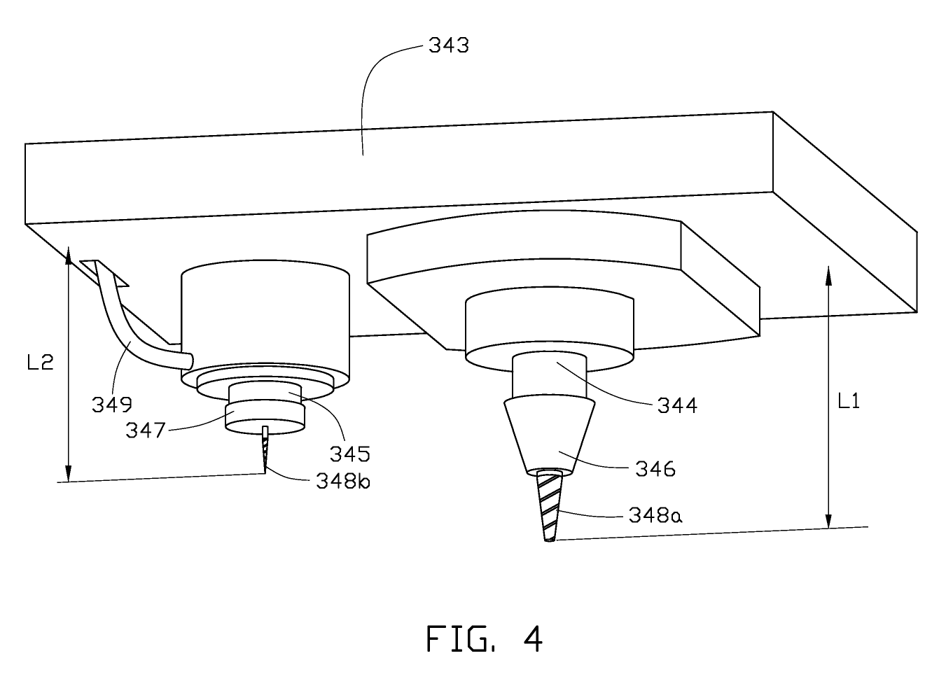

Referring to FIG. 3 and FIG. 4, the drill 34 is slidably attached to the drill holder 35 and includes a main rotator 342 and a bit holder 343. The bit holder 343 includes a first driver (not labeled) and a second driver (not labeled). The first driver includes a first rotator 344 and a first chuck 346. The first chuck 346 is configured to receive a first bit 348a and to drive the first bit 348a to rotate/spin around an axis parallel to the Z-axis. The second driver includes a second rotator 345 and a second chuck 347. The second chuck 347 is configured to receive a second bit 348b and to drive the second bit 348b to rotate/spin around an axis parallel to the Z-axis.

The slidable platform 33 includes two clamps 332 disposed thereon. The clamps 332 are driven by air pressure to hold/release a workpiece (not shown). The slidable platform 33 is made of aluminium alloy with a density in a range from about 2.7×10³ kilogram per cubic meter (hereinafter named kg/m³) to about 3.3×10³ kg/m³.

Since the slidable platform 33 is made of aluminium alloy, the slidable platform 33 is lighter than a slidable platform that is made of cast iron because the density of aluminium alloy is smaller than that of cast iron. Due to a relatively lighter weight, when the slidable platform 33 slides on the base 31, there will be less friction, thus there will be less frictional force and less momentum force on the slidable platform 33 when the slidable platform 33 slides into position on the base 31. As a result, not only can the base 31 stably slide on the slidable platform 33 which causes less positioning deviation, but can also reduce a weight and a volume of the machine tool 20. The machine tool 20 can be miniaturized. In the manufacturing field, it is known that miniaturized machine tools are particularly suitable for super precision manufacturing. Furthermore, an agility of the slidable platform 33 is improved because the slidable platform 33 is relatively light. Therefore, a precision of the machine tool 20 is high.

The first rotator 344 is driven to rotate by a motor and the second rotator 345 is driven to rotate by air pressure. Compressed air is transmitted to the second rotator 345 via a gas pipe 349. A rotational speed of the first rotator 344 is in a range from about 3000 revolutions per minute (hereinafter named rpm) to about 50000 rpm. A rotational speed of the second rotator 345 is in a range from about 50000 rpm to about 160000 rpm, and is preferred to a range from about 120000 rpm to about 160000 rpm. Preferably, the rotational speed of the first rotator 344 is about 50000 rpm, and the rotational speed of the second rotator 345 is about 160000 rpm.

The drill 34 is made of aluminium alloy with a density from about 2.7×10³ kg/m³ to about 3.3×10³ kg/m³. The drill 34 has a high conductivity because a subject with small density has a high conductivity. Since the drill 34 has good conducting properties, heat generated when the first and second rotators 344, 345 rotate can be efficiently dispersed through the drill 34. Thus, a deformation of the first and second rotators 344, 345 due to high temperatures can be prevented. Furthermore, also preventing a precision of the machine tool 20 from being affected by the deformation. In addition, an agility of the drill 34 is improved because the drill 34 is relatively light. Moreover, the machine tool 20 can be miniaturized without affecting the precision.

The first bit 348a is a rough tool and the second bit 348b is a precision tool. A diameter of the first bit 348a is in a range from about 1 millimeter to about 6 millimeters. A diameter of the second bit 348b is in a range from about 0.05 millimeters to about 1 millimeter.

In the manufacturing field, in order to improve a machining precision, precision tools are made with small diameters. Since a cutting force in precision machining being smaller than a cutting force in rough machining, precision tools with small diameters are strong enough. While, precision tools are often driven to rotate with high rotational speed so as to improve an efficiency of machining. Therefore, in the present invention, the first bit 348a with a larger diameter and mounted to the first rotator 344 having a lower rotational speed is applied in rough machining, and the second bit 348b with a smaller diameter and mounted to the second rotator 345 having a higher rotational speed is applied in precision machining. In the embodiment, a workpiece (not shown) is machined by the first bit 348a first. Then, the first bit 348a is removed from the first rotator 344. Next, the workpiece is machined by the second bit 348b. In this condition, a distance L1 from a bottom of the bit holder 343 to a distal end of the first bit 348a is larger than a distance L2 from a bottom of the bit holder 343 to a distal end of the second bit 348b.

Referring to FIG. 2 again, the cover 36 includes four sidewalls 361 and a top wall 362 connected to the sidewalls 361. Each sidewall 361 is adjoining to two other sidewalls 361. The sidewalls 361 and the top wall 362 cooperatively form a cavity. The cover 36 is mounted on the base 31 and receives the drill 34, the slidable platform 33, and the tool rack 32 therein. The cover 36 further includes a movable door 363 assembled on one of the sidewalls 361. The movable door 363 has a plurality of observing windows 364. What happens in the cover 36 when machining can be observed via the observing windows 364.

The controller 37 is positioned at one side of the cover 36 and is adjacent the movable door 363. The controller 37 is used to control movements of the drill holder 35, the slidable platform 33, and the drill 34. The controller 37 has a display 371 to display machining parameters such as positions of the first bit 348a, the second bit 348b and the slidable platform 33, and rotational speeds of the first bit 348a and the second bit 348b.

Referring to FIG. 1 again, the power cabinet 40, the dust remover equipment 50, the compressor 60, and the cooling equipment 70 are separate with a distance from the main equipment 30. In an embodiment, the power cabinet 40, the dust remover equipment 50, the compressor 60, the cooling equipment 70 and the main equipment 30 can even be set in different rooms. The power cabinet 40 is connected to the main equipment 30 by cables 401. The dust remover equipment 50 is connected to the cover 36 via a pipe 501 for absorbing dust and oil fog inside the cover 36. The compressor 60 is connected to the main equipment 30 via a windpipe 601, and provides pressured air to the slidable platform 33 and the second rotator 345. The cooling equipment 70 has a cooling pipe 701 extending to an inside of the main equipment 30. The cooling pipe 701 is filled with cooling liquid so as to cool components of the main equipment 30 such as the bit holder 343.

In the present application, heat generated from the power cabinet 40 is not transferred to the main equipment 30 because the power cabinet 40 is separate and far away from the main equipment 30. Therefore, a precision of the machine tool 20 does not worsened by heat of the power cabinet 40. In addition, when working, the dust remover equipment 50, the compressor 60, and the cooling equipment 70 fiercely shake. The shaking of the dust remover equipment 50, the compressor 60, and the cooling equipment 70 will not influence the main equipment 30, thus avoiding worsening a precision of the machine tool 20. Moreover, heat generated by the dust remover equipment 50, the compressor 60 and the cooling equipment 70 are not transferred to the main equipment 30 either. Furthermore, the machine tool 20 is easy to be relocated because the peripheral equipments are separate from each other in the machine tool 20. However, an integral machine tool that is large and heavy is difficult to be relocated. Alternatively, the machine tool 20 can only include one, two or three peripheral equipments be separate from the main equipment 30. With this condition, a precision of the machine tool 20 is lower than that having all peripheral equipments separate from the main equipment 30.

How the machine tool 20 works is described as follows. A workpiece is put on the slidable platform 33 of the main equipment 30 and held by the clamps 332 driven by air pressure. The drill holder 35, the slidable platform 33 and the drill 34 slides along the horizontal guide rails 313, the guiding grooves 314 and the vertical guiding chutes 315, i.e., parallel to the X-axis, Y-axis and Z axis, until the drill holder 35, the slidable platform 33 and the drill 34 reach an original position. Paths of the drill holder 35, the slidable platform 33 and the drill 34 are controlled by the controller 37. Then the drill holder 35, the slidable platform 33 and the drill 34 slide and the first rotator 344 rotate according to a program stored in the controller 37 to perform the roughing machining. Following, the first chuck 346 and the first bit 348a are removed from the first rotator 344. The slidable platform 33 is moved through a predetermined distance, i.e., a distance between axes of the first and second rotators 344, 345, parallel to the Y-axis. Then the drill holder 35, the slidable platform 33 and the drill 34 slide and the second rotator 345 rotates according to the program stored in the controller 37 to perform the precision machining.

The machine tool 20 has the first and second rotators 344, 345 with different rotational speeds and the first and second bits 348a, 348b with different diameters. Thereby, a roughing machining and a precision machining can perform on the same machine tool 20. Therefore, only one holding and positioning process of the workpiece is needed. Therefore, the machine tool 20 has high efficiency and precision. The first bit 348a can be removed by a tool removing device automatically. Alternatively, the first and second chucks 346, 347 and the first and second rotators 344, 345 can be retractable. Thus, the first bit 348a retracts before precision machining, and the first chuck 346 and the first bit 348a may not be removed from the machine tool 20.

In alternative embodiments, besides the slidable platform 33 and the drill 34, other movable components such as the drill holder 35 can be made of aluminium alloy with a density in a range from about 2.7×10³ kg/m³ to about 3.3×10³ kg/m³. Thereby, the machine tool 20 has a higher precision and a smaller volume. Also, the movable components can be made of other metal or alloy with small density such as magnesium alloy. The metal or alloy should be has a density of in a range from about 1.7×10³ kg/m³ to about 3.3×10³ kg/m³. The first and second bits 348a, 348b can be any kinds of cutting tools such as milling cutters.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

1. A machine tool comprising:
a main equipment having a base and a drill for mounting at least one cutting tool disposed on the base; and
at least one peripheral equipment separate from and connected to the main equipment, the at least one peripheral equipment comprising one or more of a power cabinet, a dust remover equipment, a compressor and a cooling equipment.

2. (canceled)

3. The machine tool as claimed in claim 2, wherein the power cabinet, the dust remover equipment, the compressor and the cooling equipment are all separate from and connected to the main equipment respectively.

4. The machine tool as claimed in claim 1, wherein the drill comprises a main rotator and a bit holder mounted to the main rotator, and the bit holder has a first rotator and a second rotator rotatably mounted to the bit holder.

5. The machine tool as claimed in claim 4, wherein the first rotator is driven by a motor, and the second rotator is driven by air pressure.

6. The machine tool as claimed in claim 4, wherein a rotational speed of the first rotator is in a range from about 3000 rpm to about 50000 rpm, a rotational speed of the second rotator is in a range from about 50000 rpm to about 160000 rpm.

7. The machine tool as claimed in claim 6, wherein the at least one cutting tool comprises a first bit mounted on the first rotator and a second bit mounted on the second rotator.

8. The machine tool as claimed in claim 7, wherein a diameter of the first bit is in a range from about 1 millimeter to about 6 millimeters, and a diameter of the second bit is in a range from about 0.05 millimeters to about 1 millimeter.

9. The machine tool as claimed in claim 4, wherein a preferred rotational speed of the second rotator is in a range from about 120000 rpm to about 160000 rpm.

10. The machine tool as claimed in claim 4, wherein a rotational speed of the first rotator is about 50000 rpm, and the rotational speed of the second rotator is about 160000 rpm.

11. The machine tool as claimed in claim 4, wherein the base comprises a top surface, the main equipment further comprises a tool rack and a drill holder, the tool rack comprises at least one support arm extending perpendicular from the top surface of the base, the at least one support arm is parallel to a vertical first direction, at least one horizontal guide rail is fixed to the at least one support arm, the at least one horizontal guide rail is parallel to a second direction perpendicular to the first direction, and is configured for receiving the drill holder and guiding the drill holder to slide parallel to the second direction.

12. The machine tool as claimed in claim 11, wherein the tool rack comprises a pair of support arms and a pair of horizontal guide rails, the pair of horizontal guide rails are fixed between the pair of support arms.

13. The machine tool as claimed in claim 11, wherein the main equipment further comprises a slidable platform, at least one guiding groove is defined in the top surface of the base, the at least one guiding groove runs parallel to a third direction perpendicular to the first and second directions, and are configured for receiving the slidable platform and guiding the slidable platform to move parallel to the third direction.

14. The machine tool as claimed in claim 13, wherein at least one vertical guiding chute is defined in the drill holder, the at least one vertical guiding chute is parallel to the first direction, the at least one vertical guiding chute is configured for receiving the drill and guiding the drill to slide parallel to the first direction.

15. The machine tool as claimed in claim 14, wherein the main equipment further comprises a cover, the cover is mounted on the base and receives the drill holder, the slidable platform, and the drill therein.

16. The machine tool as claimed in claim 14, wherein at least one of the drill holder, the slidable platform and the drill holder is made of metal or alloy with small density in a range from about 1.7×10³ kg/m³ to about 3.3×10³ kg/m³.

17. The machine tool as claimed in claim 14, wherein at least one of the drill holder, the slidable platform and the drill holder is made of aluminium alloy with a density in a range from about 2.7×10³ kg/m³ to about 3.3×10³ kg/m³.

18. A machine tool comprising:
a main equipment having a base and a drill for mounting at least one cutting tool disposed on the base, the base comprises a top surface, the main equipment further comprises a tool rack, a drill holder, and a slidable platform, the tool rack comprises at least one support arm extending perpendicular from the top surface of the base, the at least one support arm is parallel to a vertical first direction, at least one horizontal guide rail is fixed to the at least one support arm, the at least one horizontal guide rail is parallel to a second direction perpendicular to the first direction, and is configured for receiving the drill holder and guiding the drill holder to slide parallel to the second direction, at least one guiding groove is defined in the top surface of the base, the at least one guiding groove runs parallel to a third direction perpendicular to the first and second directions, and is configured for receiving the slidable platform and guiding the slidable platform to move parallel to the third direction; and
at least one peripheral equipment separate from and connected to the main equipment.

19. The machine tool as claimed in claim 18, wherein at least one of the drill holder, the slidable platform and the drill holder is made of metal or alloy with small density in a range from about 1.7×10³ kg/m³ to about 3.3×10³ kg/m³.
